(19) United States
(12) Patent Application Publication
(10) Pub. No.: US 2012/0159573 A1
(43) Pub. Date: Jun. 21, 2012

(54) SYSTEM, METHOD AND COMPUTER USABLE MEDIUM FOR RESTRICTING INTERNET ACCESS

(76) Inventor: Christopher Emmett Venning, Hastings, MN (US)

(21) Appl. No.: 12/971,081

(22) Filed: Dec. 17, 2010

(51) Int. Cl. G06F 21/00

(52) U.S. Cl. 726/3

(57) ABSTRACT

A method of restricting internet access includes receiving an alteration of a master internet setting within an access device's registry file and monitoring an occurrence of the alteration. Then, in response to the occurrence of the alteration, the method includes restoring the master internet setting where the master internet setting does not include the alteration. An additional exemplary method further includes storing the occurrence of the alteration in an event tracking database. In another exemplary method, the master internet setting includes a ProxyEnable setting and an AutoConfigURL setting. In another exemplary method, the ProxyEnable setting value is zero and the AutoConfigURL setting value is null. Yet another exemplary method, the access device is coupled to a computer network.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2010, Thomson Reuters.

### FIELD OF INVENTION

Various embodiments of the present invention concern systems, methods and computer usable mediums for restricting internet access.

### BACKGROUND OF THE INVENTION

For most people, the use of internet has become an integral part of life for work, leisure or both. In the workplace, the use of the internet allows companies to become more connected with their customers, suppliers and employees. For example, a car insurance customer has the option to receive an electronic insurance quote by inputting a few pieces of customer information. With this internet-based service, the customer is able to quickly decide whether to accept the quote. The internet also allows companies to interact electronically with suppliers through online purchasing and tracking For the companies' employees, the internet is utilized to receive/send email, organize appointments, download software applications, and browse for work-related information.

However, sometimes in the workplace, the internet becomes a distraction. Employees are online shopping, instant messaging with friends/family and posting items on social networking sites (e.g. FACEBOOK®/TWITTER™). Difficulties arise when employees are more focused on updating their social networking sites than focusing on their work product thus prolonging the completion time for a task. Thus these personal and/or social internet-based actions lead to possible losses in productive work time which could negatively impact the company's production and/or profits. Furthermore, some employees download software and/or access inappropriate websites that contain viruses. This concern becomes especially notable when the computer accessing the internet is connected to machinery. For example, if a virus infects a computer that is monitoring the output of a machine, the computer is shut down along with the machine in order to quarantine the virus. Often the virus-infected computer is part of an assembly line and the line gets shut down to ensure quality. This down-time significantly decreases the efficiency of not only that machine but possibly the entire assembly line, thus, creating an overall loss of production and/or profits for the company. To limit the amount of down-time, an employer may want to restrict access to certain websites or the internet altogether.

There are several known implementations to restrict access to websites and/or the internet. However, these implementations do not monitor and record an attempt to access the internet and the timestamp of the attempt. The monitoring and recording capabilities are a necessity to manage computers, and ultimately the individual employees utilizing these computers, associated with a production assembly line.

First, one known implementation utilizes the Content Advisor feature that comes with WINDOWS® INTERNET EXPLORER®. This feature allows an administrator who wants to restrict certain content to go into the “Internet Options” setting and select what types of content should be restricted and to what level. The administrator protects these settings via a password so that other users cannot alter the decisions made by the administrator. While this known implementation restricts certain content, this feature has a significant draw back in that there is an easy work around. If a user wanted to bypass the internet settings password or forgot what the password is, an internet search using the query “forgetting your content advisor password” renders several methods of disabling and/or deleting the password. In addition, this feature does not provide the monitoring and recording functionality as described above. Off-the-shelf and/or downloadable software that has restricting website/internet capability have similar limitations.

Second, a slightly more known technical implementation to restricting internet access redirects the web browser from the intended website to another IP address, such as a local machine. This solution requires a user to add a line to the computer's hosts file using a text editor redirecting the web browser to look at a local hosts file. Put another way, the local hosts file directs any requests for a web browser go to the local machine's IP address. For example, if a user tries to connect to a website with INTERNET EXPLORER®, he gets an “Internet Explorer cannot display the page” message because the local machine points to its own IP address and the webpage does not open. While using the hosts file is an option, the internet restriction only works for the one local machine. Modifying the hosts file for every computer becomes cumbersome if the user is part of a computer network of several thousand local machines. In addition, this known implementation does not provide the monitoring and recording functionality as described above.

Accordingly, the inventors have recognized the necessity for additional improvements in restricting internet access.

### SUMMARY OF THE INVENTION

A method of restricting internet access includes receiving an alteration of a master internet setting within an access device's registry file and monitoring an occurrence of the alteration. Then, in response to the occurrence of the alteration, the method includes restoring the master internet setting where the master internet setting does not include the alteration. An additional exemplary method further includes storing the occurrence of the alteration in an event tracking database. In another exemplary method, the master internet setting includes a ProxyEnable setting and an AutoConfigURL setting. In another exemplary method, the ProxyEnable setting value is zero and the AutoConfigURL setting value is null. Yet another exemplary method, the access device is coupled to a computer network. In addition, system and computer readable medium embodiments are also disclosed.

The system, method and computer readable medium described herein advantageously monitors each computer for alteration occurrences within the internet settings. If an alteration is detected (i.e. a user is trying to circumvent the internet restriction), the system monitors and stores those occurrences in an event tracking database. The monitoring feature is beneficial because management has a record of the specific tampered computer. That record then leads to a limited group or an individual accessing the computer to make the alterations thus allowing management to effectively handle the situation.

Additionally, once the user changes the internet settings, the system automatically restores the internet settings to not include the user alteration. This automatic feature lets the user know the change is not allowed and therefore internet access is not granted on the machine.

Moreover, exemplary embodiments of the present invention have the capability to be utilized across multiple individual computers or a computer network. This advantage is especially valuable for corporations or other large entities with numerous computers because of the scalability.

### BRIEF DESCRIPTION OF THE DRAWINGS

FIG. 1 is an exemplary system 100 corresponding to one or more embodiments of the invention.

FIG. 1A is an exemplary program 140 corresponding to one or more embodiments of the invention.

FIG. 2 is an exemplary method 200 corresponding to one or more embodiments of the invention.

FIG. 3 is an exemplary interface 300 corresponding to one or more embodiments of the invention.

FIG. 4 is an exemplary interface 400 corresponding to one or more embodiments of the invention.

### DETAILED DESCRIPTION OF THE EXEMPLARY EMBODIMENTS

This description, which incorporates the Figures and the claims, describes one or more specific embodiments of an invention. These embodiments, offered not to limit but only to exemplify and teach the invention, are shown and described in sufficient detail to enable those skilled in the art to make and/or use the invention. Thus, where appropriate to avoid obscuring the invention, the description may omit certain information known to those skilled in the art.

### Exemplary System for Restricting Internet Access

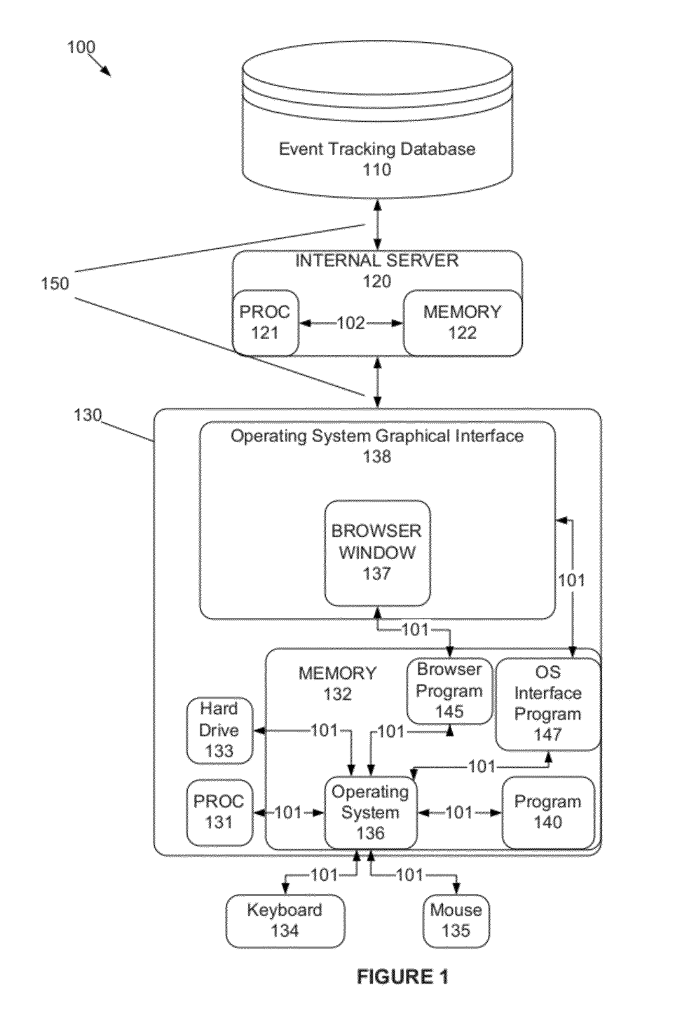

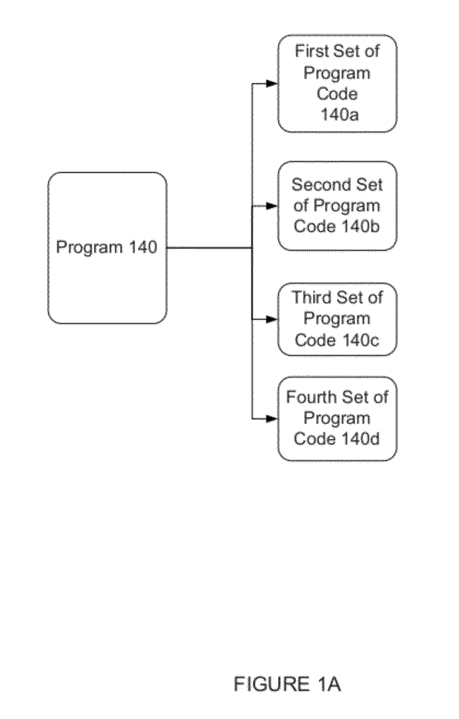

FIG. 1 shows an exemplary system for restricting internet access 100, which may be adapted to incorporate the capabilities, functions, methods, and interfaces. System 100 includes at least one event tracking database 110, internal server 120, and at least one access device 130.

Access device 130 is generally representative of one or more access devices. In the exemplary embodiment, access device 130 takes the form of a personal computer, workstation, personal digital assistant, mobile telephone, and/or any other device capable of providing an effective user interface with a server and/or database. Specifically, access device 130 includes a processor module 131, a memory 132, a hard drive 133, a operating system (OS) graphical interface 138, a keyboard 134, and a graphical pointer/selector (e.g. mouse) 135. All of these elements are connected via a computer bus 101, which is shown in various pathways throughout the access device 130. A computer bus 101 is subsystem that transfers data between access device components/elements and/or between multiple access devices.

Processor module 131 includes one or more processors, processing circuits, and/or controllers. In the exemplary embodiment, processor module 131 takes any convenient and/or desirable form known to those skilled in the art. Coupled, via computer bus 101, to processor module 131 is memory 132.

A computer readable internet restriction program 140 (herein referred to as the restriction program) is stored in memory 132 (e.g. RAM) and/or hard drive 133. Memory 132 and hard drive 133 are examples of main memory and secondary memory, respectively. Some exemplary embodiments have the restriction program 140 being stored in a computer-readable medium product of any type. In this document, the terms “computer program medium,” “computer usable medium,” and “computer readable medium” may generally refer to media such as main memory, secondary memory, removable storage drive, and/or a hard disk installed in a hard disk drive. The computer readable medium, for example, may include non-volatile memory, such as floppy, ROM, flash memory, disk drive memory, CD-ROM, CD-optical drive or disc and/or other permanent storage. Additionally, a computer readable medium may include, for example, volatile storage such as RAM, buffers, cache memory, and/or network circuits. The computer readable medium allows the computer system to read data, instructions, messages or message packets, and other computer readable information from the computer readable medium.

In one exemplary embodiment, memory 132 stores code (computer-readable and/or executable instructions) for an operating system 136, a restriction program 140, a browser program 145, and an OS (i.e. operating system) interface program 147. Operating system 136 takes the form of a version of the MICROSOFT® WINDOWS® operating system. In addition, operating system 136 interacts, via the computer bus 101, with keyboard 134, mouse 135, processor 131, hard drive 133, restriction program 140, browser program 145, and/or OS interface program 147. For example, the keyboard 134 and/or mouse 135 send inputs, via the computer bus 101, to the operating system 136. The operating system 136 determines that the restriction program 140 is the active program, accepts the restriction program input as data and stores that data temporarily in memory 132 (e.g. RAM). Each instruction from the restriction program 140 is sent by the operating system 136, via the computer bus 101, to the processor 131. These instructions are intertwined with instructions from other programs that the operating system 136 is overseeing before being sent to the processor 131. Other programs include browser program 145 and OS interface program 147. The OS interface program 147 communicates inputs/outputs, via the computer bus 101, between the operating system graphical interface 138 and the operating system 136. The browser program 145 communicates inputs/outputs, via the computer bus 101, between the browser window 137 and the operating system 136. The browser window 137 takes the form of a version of MICROSOFT® INTERNET EXPLORER®. The browser window 137 presents data in association with the set of instructions from the restriction program 140 as further discussed herein the context of the user interface example. The restriction program 140 loads, from the hard drive 133, into memory 132 every time the access device 130 is booted. The restriction program 140 executes a set of instructions, from memory 132, for ultimately restricting internet access.

FIG. 1A illustrates an exemplary embodiment of a set of instructions and/or program code for the restriction program 140. A first set of computer program instructions/code 140a is configured to receive an alteration of at least a portion of a master internet setting. Examples of an alteration and a master internet setting are further described herein. The second set of computer program instructions/code 140b is configured to monitor an occurrence of the alteration. The third set of computer program instructions/code 140c, being responsive to the occurrence of the alteration, is configured to restore the master internet setting the master internet setting not comprising the alteration. Finally the fourth set of computer program instructions/code 140d is configured to store the occurrence of the alteration of at least the portion of the master internet setting in an event tracking database.

Internal server 120 is generally representative of one or more internal servers for serving data in the form of webpages or other markup language forms with associated applets, ActiveX controls, remote-invocation objects, or other related software and data structures. In addition, internal server 120 generates a signal transmission 150 over an internal wireless or wireline communications network (not shown) to at least one access device, such as access device 130 and/or to at least one database, such as events tracking database 110. For example, a signal transmission 150 may be associated with an occurrence of an alteration of the master internet setting after storing that occurrence in the event tracking database 110. Another example of a signal transmission 150 may be associated with data which enables restoring the master internet settings. More particularly, internal server 120 includes a processor module 121 coupled to a memory module 122 via computer bus 102. Processor module 121 includes one or more local or distributed processors, controllers and/or virtual machines. In the exemplary embodiment, processor module 121 assumes any convenient and/or desirable form known to those skilled in the art. Memory module 122 takes the exemplary form of one or more electronic, magnetic, and/or optical data-storage devices.

An event tracking database 110 is a storage database where occurrences of alterations of the master internet settings are stored. Exemplary occurrences of alterations of the master internet settings are described within the exemplary method section. Database 110, takes the exemplary form of one or more electronic, magnetic, and/or optical data-storage devices. Database 110 is coupled or couplable via an internal server 120 and an internal wireless or wireline communications network (not shown), such as a local-, wide-, private-, or virtual-private network, to access device 130.

### Exemplary Method for Restricting Internet Access as Performed in System 100

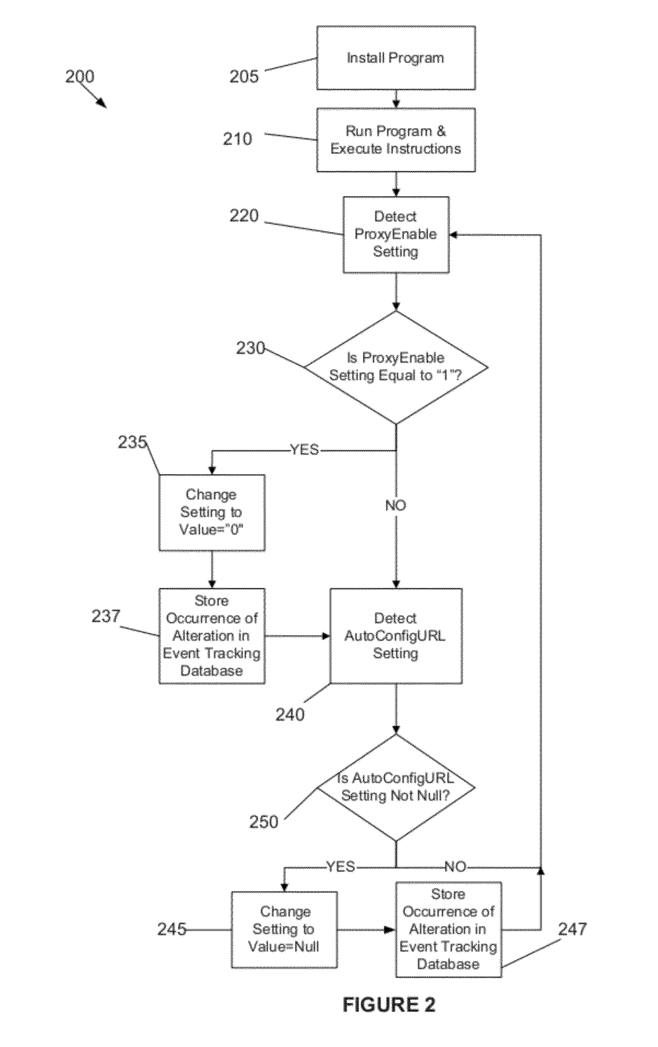

Referring now to FIG. 2, the restriction program 140 is configured to implement method 200, which may be adapted to incorporate the capabilities, functions, systems, and interfaces. Method 200 includes functional blocks 205-247. These functional blocks are steps that perform actions including assignments, decisions, assessments and other like functions.

In step 205, a one-time installation of the restriction program 140 on access device 130 occurs. In the beginning of the installation process, the restriction program 140 prompts the user for a password into order to initiate the rest of the installation. There are several methods to setting up and receiving a password for the user to input. In one example, an administrator creates a password and only he/she has access to it. Thus, the administrator is the only one that can install the restriction program 140 on the access device 130. In another example, the administrator creates and delivers a new password, either programmatically and/or manually, for a pre-determined amount of time (e.g. daily, weekly, monthly, etc.) to trusted users that install the restriction program 140. Programmatic password creation and delivery use techniques already known to those skilled in the art. For example, the programmatic delivery of a password might be done by email notification. In some exemplary embodiments, if the password is not entered successfully within a certain number of attempts, the restriction program 140 blocks the user from being able to login and ultimately install the restriction program 140. In other embodiments, each unsuccessful login attempt is monitored and stored within the events tracking database 110. On the other hand, if the password has been successfully entered, the successful installation action is monitored and stored within the events tracking database 110 and the restriction program 140 completes the one-time installation on the hard drive 133 of the access device 130. More specifically, in some embodiments, the program files are stored in the directory folder (e.g. WINDOWS® directory folder). Storing the program files in the directory folder provides a kind of “hiding” spot. Most users do not go into and modify directory folders thus keeping the restriction program 140 “hidden” in plain sight.

In step 210, once installation on the hard drive 133 is complete, the restriction program 140 immediately loads into the memory 132, thus eliminating a re-boot of access device 130. The instructions within the restriction program 140 are executed. These instructions include detecting a set of internet settings, preferably, the ProxyEnable and AutoConfigURL settings. In order for the restriction program 140 to be effective in restricting internet access, the internet settings have restriction values. These restriction values compose the master internet setting and are as follows:
ProxyEnable setting value=“0”
AutoConfigURL setting value=“Null”
   Once the master internet settings are set within the access device 130, the user is unable to access the internet. Steps 220 through 245 provide further detail around the configuration of the ProxyEnable and AutoConfigURL settings within the access device 130.

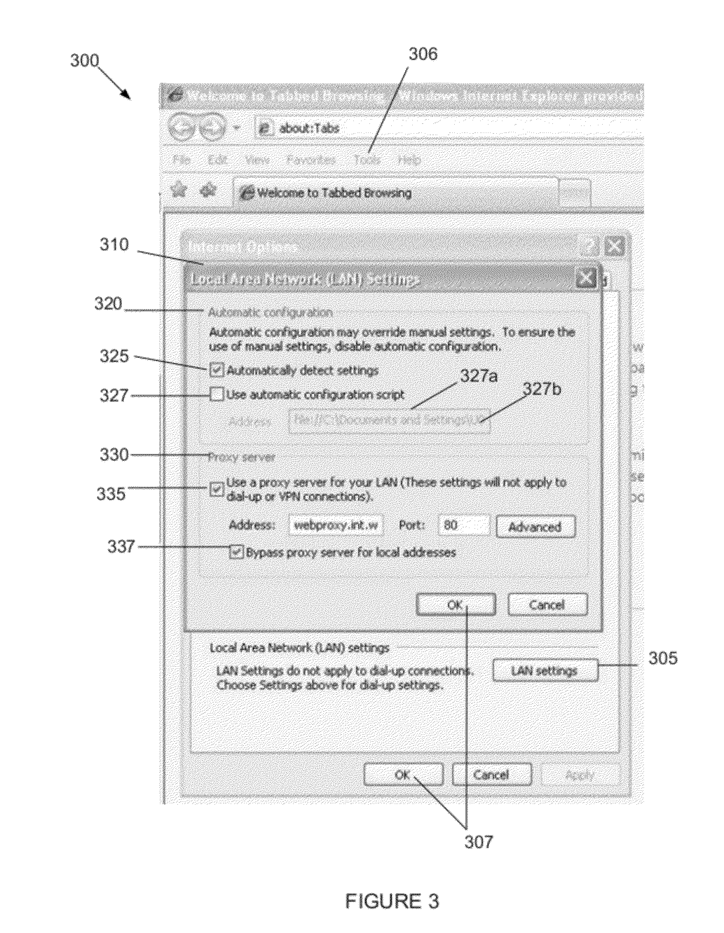

In step 220, the restriction program 140 searches the access device's registry file to locate the ProxyEnable setting. The ProxyEnable setting controls whether a proxy server is enabled. The ProxyEnable value configures the “Use proxy server for your LAN” box 335 (see FIG. 3) within the internet options of the browser 137.

Once the ProxyEnable setting is detected, step 230 determines if the ProxyEnable value is “0” or “1.” If ProxyEnable setting is set to “1”, then use of a proxy server is enabled. If ProxyEnable setting is set to “0”, then the browser does not enable a proxy server. Since the purpose of the present invention is to restrict internet access, a portion of the master internet setting is ProxyEnable value=“0.” Therefore if the value of the setting is already “0” then no changes are needed to the registry file and the process moves to step 240. However, if the value=“1” then the ProxyEnable setting value is changed to “0” in block 235. If during the running of the restriction program 140, any change in value occurs to a portion of the master internet setting (e.g. ProxyEnable setting changes from “0” to “1”), that change is considered an alteration. These alterations are important to the user because changing and/or restoring the values to equate to the master internet setting values ultimately restricts access to the internet.

The restriction program 140 receives the alteration and monitors the occurrence of that alteration. Any instructions and/or actions are being monitored. Monitoring examples include installation/un-installation, password generation, password attempts, occurrences of alteration, restoration of master internet setting and the like. Furthermore, in response to the occurrence of the alteration, the restriction program 140 restores the alteration value to the master internet setting value. Thus, a user's internet access is restricted.

Some alterations happen when a user installs the restriction program 140 for the first time. For example, the access device's initial internet settings may not have been set to the master internet settings. Therefore, an alteration is detected when the initial internet setting values change to the master internet setting values. Other alterations are due to a user attempting to circumvent the internet restriction. Any occurrence of an alteration is monitored and stored in a database. Preferably, all occurrences of alterations are then stored in step 237 in an event tracking database 110. However, additional embodiments filter and store only the circumvention occurrences of alterations of the master internet settings using teachings already known to those skilled in the art. Another embodiment includes a notification step (not shown). For example, the notification step sends an automatic email to an administrator and/or trusted user notifying her that an alteration has taken place. Additionally, the automatic email may provide a link to where the occurrence is being stored in the event tracking database 110. Other embodiments allow for an administrator or trusted user to have access to the events tracking database 110 to search for specific or all alterations.

After the ProxyEnable setting is detected, step 240 detects the AutoConfigURL setting which is also located in the access device's registry file. The AutoConfigURL setting enables a user to specify the file that contains the information about the browser settings, such as the browser title and start page, every time the browser 137 is started.

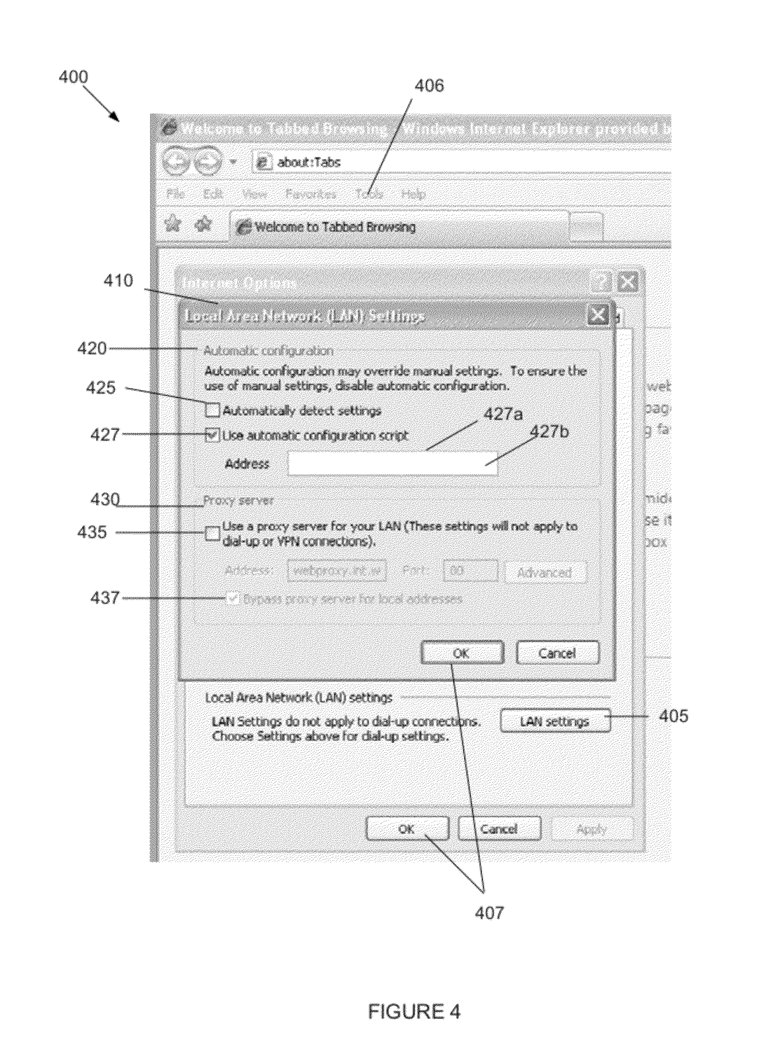

Step 250 determines if the value of the AutoConfigURL setting is not equal to null. If AutoConfigURL setting is equal to null, then the browser is not configured to access a file containing proxy and other settings. If AutoConfigURL setting is not equal to null, then the browser is configured to access a file containing proxy and other settings. For example in FIG. 3, the file 327b is “file://C:\Documents and Settings\U0.” If a file 327b is populated in “Address” box 327a, the browser 137 uses the file containing proxy and other settings to access the intended webpage. However, as shown in FIG. 4, if there is no file 427b populated in “Address” box 427a, then an error message webpage displays. Since the purpose of the present invention is to restrict internet access, a portion of the master internet setting is the AutoConfigURL value equal to null. Therefore if the value of the setting is null then no changes are needed to the registry file. Yet, if the value is not equal to null, the AutoConfigURL setting value is changed to null in block 245. This change in value is considered an alteration and should be monitored and restored as previously described. Preferably, all occurrences of alterations are then stored 247 in an event tracking database 110. However, additional embodiments filter and store only the circumvention occurrences of alterations of the master internet settings using teachings already known to those skilled in the art.

Once the method 200 has finished detecting the AutoConfigURL setting value, the restriction program 140 re-executes by detecting the ProxyEnable setting value 220 and repeats steps 220 through 247 until the user decides to power down the access device 130. In some embodiments, the restriction program 140 waits a pre-determined amount of time before re-executing step 220. For example, pre-determined amounts of time are seconds, fractions of a second, minutes, hours, days and the like. In other embodiments, the restriction program 140 runs in a continuous executable loop. In addition, the restriction program 140 does not have to start with the detecting the ProxyEnable setting. One of ordinary skill in the art could have additional steps and place the detection steps in a different sequential order or in parallel.

### User Interface

FIG. 3 illustrates an exemplary interface that the user sees when trying to connect to the internet via a proxy server. This interface displays when the user accesses the Internet Options under the “Tools” section 306 of the browser menu and selects the “LAN settings” button 305. The LAN settings 310 have two sections: Automatic Configuration 320 and Proxy Server 330. In this exemplary embodiment, these sections have an initial setting that is not part of the master internet setting.

Within the Automatic Configuration section 320 and the Proxy Server section 330, the “Automatically detect settings” setting check box 325, the “Use a proxy server for your LAN” setting check box 335 and the “Bypass proxy server for local addresses” setting check box 337 are selected. The restriction program 140 runs across the abovementioned settings and changes them, if necessary, to equate with the master internet setting described herein. Afterwards, the user sees the following settings in FIG. 4 within the LAN settings 410:
“Automatically detect settings” setting check box 425 un-checked;
“Use automatic configuration script” setting check box 427 checked with no file 427b populated in the “Address” box 427a;
“Use a proxy server for your LAN” setting check box 435 un-checked; and
“Bypass proxy server for local addresses” setting check box 437 grayed out (i.e. the box cannot be checked or unchecked).

However, if a user decides to alter the settings listed above, the restriction program 140 recognizes the setting has been altered and restores the altered setting to the master internet setting. The restoration is displayed to the user by automatically checking and un-checking the appropriate check boxes. For example, in referring back to FIGS. 3 and 4, if a user checks the “Use a proxy server for your LAN” setting check box 335, the ProxyEnable setting within the registry file is changed from “0” to “1.” Once the restriction program 140 has a chance to detect the ProxyEnable setting again, it recognizes that the setting is not equating to a portion of the master internet setting. The restriction program 140 then changes the setting back to “0” and stores this occurrence with the events tracking database 110. Simultaneously, when the ProxyEnable setting is restored to “0,” the user sees, in FIG. 4, that the “Use a proxy server for your LAN” setting check box 435 has been automatically un-checked. This automatic checking happens in the pre-determined time interval selected when determining how often the restriction program 140 re-executes. Preferably, referring to FIG. 3, the time period is a second or less because the user cannot select the appropriate check boxes 325, 327, 335, click the “OK” buttons 307 and gain access to the internet within that time period. Furthermore, in FIG. 3 the “Bypass proxy server for local addresses” setting 337 is not strictly monitored because the “Use a proxy server for your LAN” setting 335 overrides the bypass setting 337. Thus when the “Use a proxy server for your LAN” setting check box 435 remains un-checked, in FIG. 4, the “Bypass proxy server for local addresses” setting check box 437 is grayed out so the user cannot modify the setting.

### CONCLUSION

The embodiments described above and in the claims are intended only to illustrate and teach one or more ways of practicing and/or implementing the present invention, not to restrict its breadth and/or scope. For example, access device 130 can directly communicate with the event tracking database 110 without the need to communicate through internal server 120. The actual scope of the invention, which embraces all ways of practicing and/or implementing the teachings of the invention, is defined by the claims and their equivalents.

1. A method for restricting internet access comprising:
a. receiving an alteration of at least a portion of a master internet setting within a registry file of an access device;
b. monitoring an occurrence of the alteration; and
c. in response to the occurrence of the alteration, restoring the master internet setting, the master internet setting not comprising the alteration.

2. The method of claim 1 further comprising storing the occurrence of the alteration of at least the portion of the master internet setting in an event tracking database.

3. The method of claim 1 wherein the master internet setting comprises a ProxyEnable setting and an AutoConfigURL setting.

4. The method of claim 3 wherein a value for the ProxyEnable setting is zero.

5. The method of claim 3 wherein a value for the AutoConfigURL setting is null.

6. The method of claim 1 wherein the at least one access device is coupled to a computer network.

7. A system for restricting internet access comprising:
a. at least one access device, the at least one access device comprising a processor;
b. a memory coupled to the processor; and
c. a set of computer readable internet restriction program instructions executable by at least one of the memory and the processor, the set of computer readable internet restriction program instructions configured to:
i. receive an alteration of at least a portion of a master internet setting;
ii. monitor an occurrence of the alteration; and
iii. restore the master internet setting, responsive to the occurrence of the alteration, the master internet setting not comprising the alteration.

8. The system of claim 7 wherein said instructions are further configured to store the occurrence of the alteration of at least the portion of the master internet setting in an event tracking database.

9. The system of claim 7 wherein the master internet setting comprises a ProxyEnable setting and an AutoConfigURL setting.

10. The system of claim 9 wherein a value for the ProxyEnable setting is zero.

11. The system of claim 9 wherein a value for the AutoConfigURL setting is null.

12. A computer-usable medium having a computer readable internet restriction program embodied therein, the computer readable internet restriction program comprising:
a. a first set of computer program code configured to receive an alteration of at least a portion of a master internet setting;
b. a second set of computer program code configured to monitor an occurrence of the alteration; and
c. a third set of computer program code, responsive to the occurrence of the alteration, configured to restore the master internet setting, the master internet setting not comprising the alteration.

13. The computer-usable medium of claim 12 further comprises a fourth set of computer program code configured to store the occurrence of the alteration of at least the portion of the master internet setting in an event tracking database.

14. The computer-usable medium of claim 12 wherein the master internet setting comprises a ProxyEnable setting and an AutoConfigURL setting.

15. The computer-usable medium of claim 14 wherein a value for the ProxyEnable setting is zero.

16. The computer-usable medium of claim 14 wherein a value for the AutoConfigURL setting is null.
